(19) United States
(12) Patent Application Publication
(10) Pub. No.: US 2004/0064708 A1
(43) Pub. Date: Apr. 1, 2004

(54) Zero administrative interventions accounts

(75) Inventors: Michael F. Angelo, Houston, TX (US); Manuel Novoa, Cypress, TX (US); John A. Carchide, Stoneham, MA (US)

Correspondence Address: CONLEY ROSE, P.C., P. O. BOX 3267, HOUSTON, TX, 77253-3267, US

(73) Assignee: Compaq Information Technologies Group, L.P., Houston, TX (US)

(21) Appl. No.: 10/260,892

(22) Filed: Sep. 30, 2002

(51) Int. Cl. H04K 1/00

(52) U.S. Cl. 713/185

(57) ABSTRACT

A security token is used to dynamically create a user account on a host computer system. The token preferably is programmed with a user's credentials which includes information regarding the user account and security data. Once programmed, the token then can be inserted into a host computer. The user verifies himself or herself to the host computer/token and the token verifies itself to the host computer. Once verified, the user's credentials stored on the token are accessed to dynamically create the user account on the host system. The token may comprise a smart card, USB-compatible memory device, and the like. Storage media, such as floppy disks, also can be used if fewer security features are acceptable.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to user accounts on computer systems. More particularly, the invention relates to user accounts on a non-networked computer and more particularly still, to the use of tokens to set up user accounts on non-networked computers.

2. Background of the Invention

Many organizations have a computer network comprising a plurality of computers electrically or wirelessly coupled together according to a known architecture over which data is transferred in accordance with predetermined protocols. Typically, a user can log on to any one computer (generically referred to as a “node”) and, once logged on, can access the network's resources such as email, printing, network stored files, etc. There are many uses of a computer network and numerous associated configurations and protocols, as is well known in the art.

The inclusion of a new computer into the network typically requires some type of intervention on the part of a network administrator or information technology (“IT”) personnel to configure the computer before it can be used as a node in the network. In fact, it often is desirable to be able to set up and configure a computer before it is accessible to the network.

Many computers have been enabled with logical user access controls, meaning that a user must log on to the computer before being able to use it. In some instances, the verification of the user's password is provided via a service over the network. Obviously, this will not be possible if the computer does not yet have network access. Also, it is possible to set up a local account on the computer to permit access to the computer without network password verification. In this case, the password is verified locally by the computer. A user can only access the computer using the locally set up account if, in fact, the account has already been set up for the user. If no account has been set up locally and no network access is provided, the user will not be able to access the computer. Thus, a problem exists of how to provide a user access to a computer that does not have network access and on which a suitable local account has not yet been created.

### BRIEF SUMMARY OF THE INVENTION

The problems noted above are solved in large part by the use of a security token to dynamically create a user account on a host computer system. The token preferably is programmed with a user's credentials which includes information regarding the user account and security data. Once programmed, the token can be used to create an account on a host computer. The user inserts the token in a host computer and verifies himself or herself to the host computer and the token. The token also verifies itself to the host computer using the security data. Once verified, the user's credentials stored on the token are accessed to dynamically create the user account on the host system. The token may comprise a smart card, USB-compatible memory device, and the like. Storage media, such as floppy disks, also can be used if fewer security features are acceptable.

Once the user account is dynamically created on the host system, the account may be left in place or deleted when the user logs off. Further, the token's credentials may encode a validity time period which specifies or otherwise indicates a period of time during which the token is viable to create or permit use of the dynamically created user account. Also, if desired, the token can be implemented in a way that requires the user to recharge the token once every specified unit of time (e.g., once per day, once per week, etc.). These and other features and benefits will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 shows a token configuration system in accordance with the preferred embodiment of the invention in which a token can be programmed with user account information;

FIG. 2 shows a preferred method of programming a token with user account information;

FIG. 3 shows a host computer system in which the token can be inserted to dynamically establish a user account; and

FIG. 4 shows a preferred method of verifying the token before permitting the user account to be established.

### NOTATION AND NOMENCLATURE

Certain terms are used throughout the following description and claims to refer to particular system components. As one skilled in the art will appreciate, computer and computer-related companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

The problem noted above is solved by providing dynamic creation of a local account by use of a “security token.” A security token (or simply “token”) is a portable device which can be accessed by a computer system. A token generally provides an increased level of security when attempting to access the computer system. In accordance with the preferred embodiment of the invention, a user (e.g., a network administrator, IT professional, etc.) can generate specific information and have such information written to a token. The information may include account information and security data. The user then can take the token to the host computer to which the user desires access and insert the token into the host computer. Through a security verification process, the host computer verifies the authenticity of the token using the security data and dynamically generates a local user account on the host in accordance with the account information stored on the token. As such, a local account advantageously need not be created ahead of time for the user and the computer need not have access to a network.

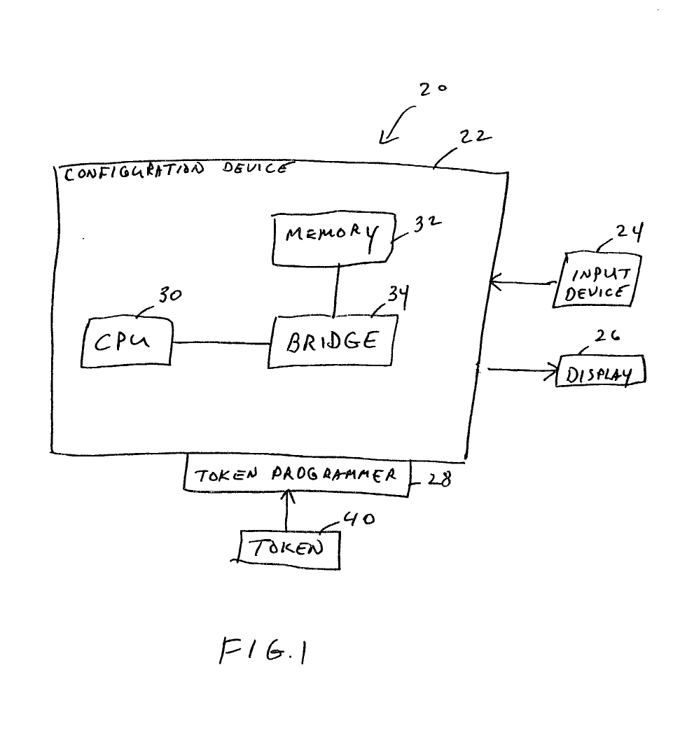

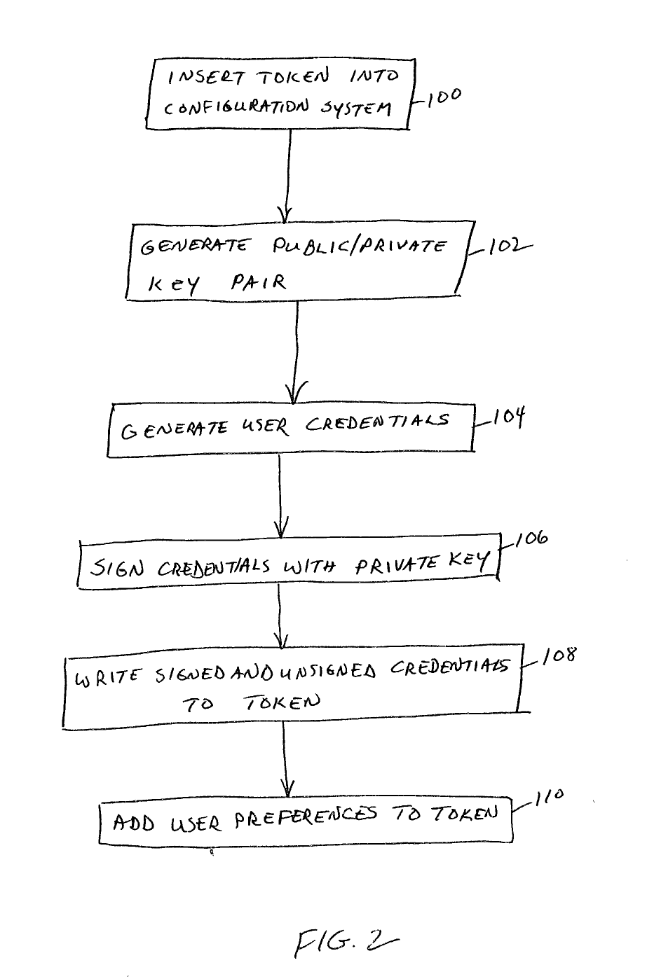

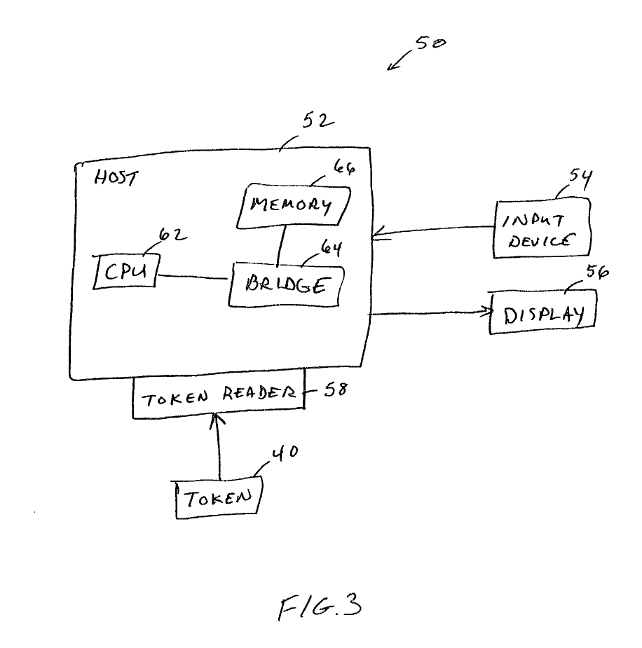

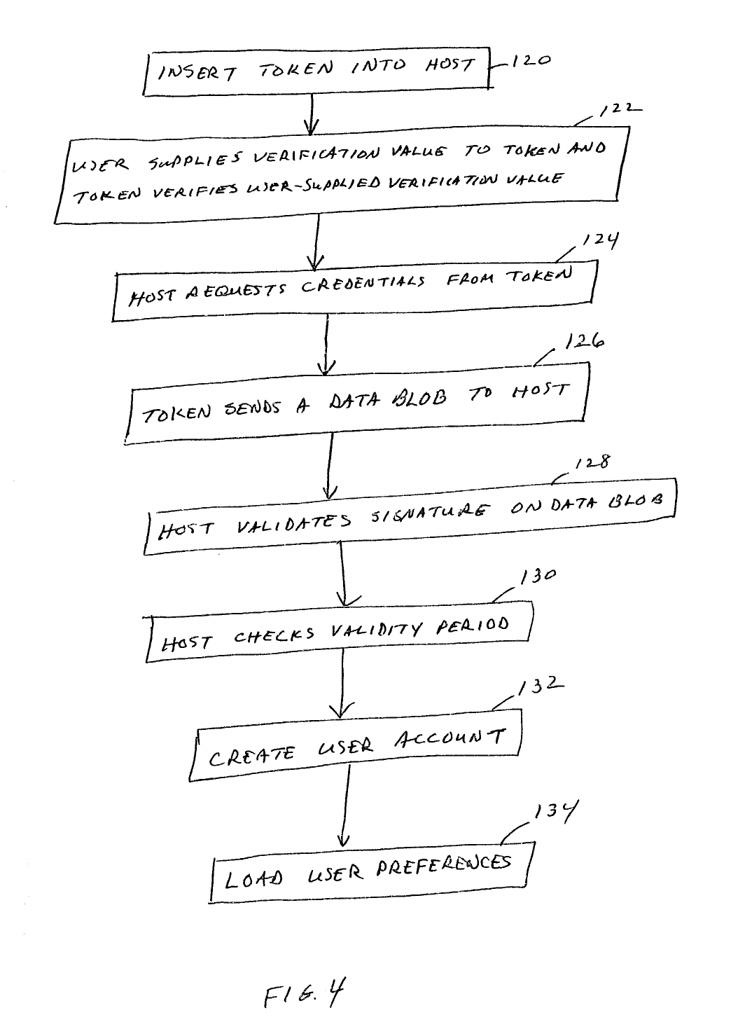

FIGS. 1-4 illustrate a preferred embodiment of this principle. FIG. 1 depicts an exemplary configuration system in which the token can be created and FIG. 3 depicts a host computer system in which the token is inserted and on which the user account is generated. FIGS. 2 and 4 depict methods associated with the systems of FIGS. 1 and 3 to create and use the token.

Referring now to FIG. 1, configuration system 20, in accordance with a preferred embodiment, comprises a configuration device 22 to which an input device 24 (e.g., keyboard, mouse, etc.) and display 26 couple, as well as a token programmer 28. The configuration device 22 preferably comprises a computer system and, as such, includes a central processing unit (“CPU”) 30 and memory 32 coupled to a bridge logic device 34. The token programmer 28 may be included as part of the configuration device 22 or as a separate component coupled to the configuration device via an electrical cable. A token 40 is insertable into token reader 28. The token may comprise a universal serial bus (“USB”)-based memory device such as the ThumbDrive by Trek or the DiskOnKey by M-Systems. Alternatively, the token may comprise a “Smart Card” which contains flash memory, as well as any device providing the capabilities described herein. The token programmer 28, of course, should comport with the type of token 40 that is used. If the token comprises a USB memory device, the programmer may comprise USB bus logic and associated drivers and applications usable to write to the token 40. In general, once the token 40 inserted, the configuration device 22 can write data to the token, and also read information from the token as well. Reference may be made to U.S. Pat. No. 6,182,892 and “Security Tokens” by Mike Fratto, Aug. 20, 2001, available at www.networkcomputing.com/1217/1217buyer52.html for further explanation of tokens. Both of these references are incorporated herein by reference.

FIG. 2 illustrates an exemplary series of actions that may be performed by configuration system 20 to generate a token. Most of this functionality is performed by software running on the configuration device 22 as would be understood by one of ordinary skill in the art. In block 100, an administrator or other person inserts a token 40 into the token reader 28. At 102, the configuration system then preferably generates a private key/public key pair in accordance with any well known technique. As is well known, a private key and associated public key are mathematically linked. A private key can be used to encrypt data and, only the associated public can be used to reverse the encryption process and decrypt the encrypted data. Alternatively, the public key can be used to encrypt data with the private key being used in the decryption process.

In block 104, user “credentials” are generated via configuration system 20. These credentials may include the public key generated in 102, one or more user privileges, a validity time period for the account the token is permitted to create, and other desired information. The validity period comprises a time period during which the token can be used by a user to access a desired computer. The validity period may comprise a specific date signifying the end of the validity period. Alternatively, the validity period may simply be a period of time (e.g., one day, one week, etc.). In general, the credentials include information which permits a computer on which the token 40 is used to dynamically set up a local account.

At 106, the configuration system 20 signs the user credentials preferably using the private key generated in 102. Digital signatures are well known to those of ordinary skill in the art. In general, a “hash” value is computed for the credentials by running the credential information through a hash function. As is commonly known, a hash function comprises a mathematical transformation that takes an input (e.g., the user credentials) and returns a fixed-size “hash value.” When used in cryptography, hash functions preferably are “one-way” functions meaning that, given a hash value, it is very difficult (i.e., computationally impractical) to find an input that, after being hashed, will generate a given hash value. Hash functions are well known in the art and their explicit structures are beyond the scope of this disclosure. However, reference can be made to U.S. Pat. Nos. 6,424,953, 6,199,167 and 5,887,131, incorporated herein by reference, for further descriptions of hash functions. Signing the user credentials in 106 involves computing a hash value for the user credentials using a suitable predetermined hash function, such as those hash functions that are well known, and encrypting the hash value using the private key, a process that is also well known.

Then, at 108 the configuration system writes the signed and unsigned versions of the user credentials to the token 40. Finally, the user may add his or her own configuration preferences to the token 40 in block 110. Such preferences may include configuration information for the operating system's graphical user interface, application handling preferences (i.e., word set up), device configuration access—such as USB, etc.

At this point, the token 40 has been created and the user may then remove the token from the token programmer 28. As explained above, the token 40 is portable and thus may be transported to and inserted into whatever host computer the user desires to access. FIG. 3 shows a preferred embodiment of a host computer system 50 that a user of a token may desire to access, such as to configure the machine for subsequent use by a data operator. As shown, the computer system 50 includes a host computer 52 to which an input device 54 (e.g., keyboard, mouse) and display 56 are coupled. The host includes a CPU 62, bridge 64 and memory 66 coupled together as shown, or coupled together in different configurations. A token reader 58 also is provided as part of the host 52 or as a separate component cabled to the host. The token reader 58 may comprise the same device as the token programmer 28 of FIG. 1 or comprise a device that only permits tokens to be read, not programmed. As was the case of the token programmer 28 of FIG. 1, token reader 58 may permit a token 40 provided as a USB memory device to be accessed by the host 52. As such, the reader may include a USB bus and associated drivers and applications.

FIG. 4 depicts a series of actions that preferably are performed so as to use the token 40 in host 52. In block 120, the user inserts the token 40 into the token reader 58. This action causes host 52 to perform a two-way verification process whereby the user verifies himself or herself to the token 40 and the token verifies itself to the host. Preferably, when both verifications are successfully completed, a local account is created on the host 52 thereby permitting access by the user. Accordingly, in block 122, the user is prompted to enter a user verification value (which may be a credential). The verification value in block 122 need not be the same credential as that created in block 104 of FIG. 2. The user verification value in block 122 may include a password known to the user of the token and externally entered via input device 54. Alternatively, the user verification value may include biometrics data (e.g., fingerprint, retinal scan, etc.). In this latter case, a biometric template is created a priori in accordance with well known techniques and stored on the token 40. The input device 54 may include a biometric imager, such as a fingerprint scanner or retinal scanner, and the user can have his or her fingerprint or retina scanned by the host for verification of the user. Fingerprint and retinal scanning for verification are well known and are described in numerous references, such as U.S. Pat. Nos. 6,104,922 and 6,347,040, incorporated herein by reference.

If a biometric template is written to the token for user verification, it is desirable, although not mandatory, to prevent the template from being altered as well as verifying that it is an approved template. Accordingly, the user preferably signs any biometric template stored on the token 40 using any suitable digital signature process such as the process explained above with regard to block 106 in FIG. 2. To validate the user via his or her biometric template, block 122 further includes the template being copied from the token to the host 52 which then validates the signature on the template. If the signature is found to be valid, the host 52 then prompts the user for biometric presentation (e.g., the user is prompted to place his or finger on a fingerprint scanner) and verifies the biometric image captured from the user.

Once the user has verified himself or herself to the token 40, the credential stored on the token during the token creation process of FIG. 2 preferably is verified to the host 52, before the credential can be used to set up the user account. Accordingly, in block 126 the token 40 sends a “data blob” to the host 52. A data blob generally comprises a formatted sequence of data bits, without referring to any particular format or content for the data. In the current case, the data blob preferably includes the signed and unsigned credentials from the token 40. In block 128, the host 52 validates the signature on the data blob. This process is performed preferably by computing a hash value on the unsigned credential using the same hash function as was used to sign the credential in FIG. 2. Further, the public key included in the unsigned credential is used to decrypt the signed credential. Then, the two hashes (the newly computed hash and the decrypted hash) are compared. If the hash values match, then the token's credential is considered to be validated. Otherwise, the credential is considered not to be valid and no further access to the host computer system 50 is permitted, or other appropriate security response can be performed (e.g., writing a message to a security log on host 52 to memorialize the failed token verification).

Once the token's credential is verified, the credential is examined by the host 52 to determine if the validity time period has expired if a validity period is encoded in the credential. If, in fact, the validity period has expired, the user preferably is not permitted further access to the host computer system 50 as noted above in the case where the user-supplied credential in block 122 cannot be validated. If the validity period has not expired, or there is no validity period, the user's account is dynamically created (block 132) and, if included on the token, the user's preferences may also be loaded onto host 52 (block 134). The user account can be set up in accordance with a variety of techniques and generally is specific to the particular computer 52 and operating system running thereon. Setting up the account may include writing various known account files to memory 66 or a hard drive (not shown).

If desired, the credential on the token can be encoded in a manner to require the token to be “recharged” once per unit of time (“periodically”) to avoid the token being unusable to access a host system 50. The recharge process may include inserting the token 40 into the configuration system 20 which, when prompted to recharge the token, verifies the token and updates or resets a value in the credential stored on the token. The period for recharge can be any desired period of time such as one day, one week, etc. During the predesignated period of time, the user of the token must recharge the token device. If the user fails to recharge the token, the un-recharged token will not be usable when inserted into a host 52. The process of verifying the validity of the token can include examining a particular recharge value on the token to determine if that value has been appropriately updated in accordance with the recharge period of time. In one embodiment, the recharge value comprises an integer which is incremented by one each day to keep the value recharged. If it has been three days since a host 52 has last been given the token 40, the host determines whether the token's recharge value comprises an integer that is three greater than the last time the host 52 read the token. If this is not the case, the host will not permit the user further access. This feature generally provides a measure of security of the token should the token ever be stolen or otherwise fall into unauthorized control.

In accordance with an embodiment of the invention, the credentials (which include user account information) on the token 40 can be used to set up a permanent account on host 52. This permits the user to access the account in the future without using the token. In this case, the token 40 provides the means to dynamically create a user account on a host computer which can be used thereafter without the use of the token. Alternatively, the user account created by token 40 may be temporary in nature. As such, when the user logs out of the account created by the token, the account is deleted from the host 52, preferably along with the user's preferences. Further still, accounting and other log files, that form part of a user account, may be left in place on the host with the user's credentials there as well. In the case where the authorization file contains a lookup tag which can point back to the user, the account could be left in place on the host, however, locked out preventing further use.

Further still, the token 40 may also contain application(s) that the user of the token may desire have loaded onto the host 52. The applications may be loaded onto the token during the token creation process generally depicted in FIG. 2 and further may be included as part of the user's preferences (block 134). After loaded onto the host 52, the applications can be left in place or deleted when the user logs out of the host. Also, the applications can be left on the host, but software locked to prevent subsequent use by anyone other than the user.

The embodiments described above generally provide a mechanism and means for dynamically creating a user account on a host computer using a portable token device. The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of managing a user account on a computer, comprising:
(a) inserting a token into the computer, said token comprising user account information and security data which permits the user account information to be verified;
(b) verifying a user of said token;
(c) verifying said security data on said token; and
(d) creating said user account if said security data is successfully verified.

2. The method of claim 1 wherein (b) includes providing a user verification value and verifying said user verification value.

3. The method of claim 2 wherein said user verification value comprises a password and a copy of said password is stored on said token.

4. The method of claim 2 wherein said user verification value comprises a biometric value, a biometric template is stored on said token and verifying said user verification value comprises verifying the biometric value obtained from the user against the biometric template stored on the token.

5. The method of claim 4 wherein said biometric value comprises a fingerprint image.

6. The method of claim 4 wherein said biometric value comprises a retinal scan.

7. The method of claim 1 wherein said security data comprises a hash of said account information.

8. The method of claim 1 wherein said security data comprises an encrypted hash of said account information.

9. The method of claim 8 wherein said encrypted hash was encrypted using a private key.

10. The method of claim 8 wherein (c) includes retrieving said signed hash and said account information from said token, computing a hash of said account information obtained from said token, decrypting said signed hash to produce a decrypted hash, and comparing the decrypted hash to the hash retrieved from the token.

11. The method of claim 10 wherein (c) further includes determining the security data to be verified if said decrypted hash and retrieved hash match.

12. The method of claim 1 wherein the token also includes a validity time period value and the method further includes determining whether the validity time period has expired.

13. The method of claim 12 wherein (d) includes creating said user account if said security data is successfully verified and said validity time period has not expired.

14. The method of claim 1 further including deleting said user account when said user logs off said computer.

15. A method of creating a token usable to dynamically create a user account on a computer, comprising:
(a) inserting the token into a token programmer coupled to a configuration system;
(b) generating a private key;
(c) generating user credentials containing user account information and a security value, said user credentials usable to create a user account on said computer upon insertion of said token into said computer; and
(d) writing said user credentials to said token.

16. The method of claim 15 further including generating a private key and public key pair and signing said account information with said private key.

17. The method of claim 16 wherein said security value comprises a signed hash of said account information.

18. The method of claim 15 further including generating user preferences and writing said user preferences to said token.

19. The method of claim 15 further including recharging said token before the expiration of recharging period of time, said recharging including inserting said token into said configuration system and updating a value stored on said token.

20. A token, comprising:
memory;
an interface coupled to said memory and usable to couple said token to a computer;
wherein said memory contains user account information which permits a user account to be created on a computer and security data which permits the user account information to be verified.

21. The token of claim 20 wherein said memory also includes user preferences.

22. The token of claim 20 wherein said security data comprises a hash of said account information.

23. The token of claim 20 wherein said security data comprises an encrypted hash of said account information.

24. The token of claim 23 wherein said encrypted hash was encrypted using a private key.

25. A token configuration system, comprising:
a CPU; and
a token programmer coupled to said CPU and configured to receive a token;
wherein said CPU writes user account information and security data to said token, said user account information usable to permit a user account to be created using the token and said security data usable to permit the user account information to be verified.

26. The token configuration system of claim 25 wherein said account information includes a validity time period value indicative of a time period during which said token is viable to create the user account.

27. The token configuration system of claim 26 wherein said CPU alters said validity time period when said token is inserted into the programmer after the user account and security data have been written to the token.

28. The token configuration system of claim 25 wherein said CPU generates said security value to include a hash of said account information.

29. The token configuration system of claim 25 wherein said CPU generates said security value to include a signed hash of said account information.

30. The token configuration system of claim 25 wherein said CPU writes user preferences to said token.

31. The token configuration system of claim 25 wherein said token programmer comprises a USB.

32. A computer system comprising:
a CPU; and
a token reader coupled to said CPU and configured to receive a token;
whereby said token includes user account information which is read by said CPU and used to create a user account.

33. The computer system of claim 32 wherein said token also includes a security value and said CPU verifies said token using said security value.

34. The computer system of claim 32 further including an input device coupled to said CPU via which a user enters a verification value which said CPU verifies.

35. The computer system of claim 34 wherein said input device comprises a keyboard and the verification value includes a password.

36. The computer system of claim 34 wherein the input device includes a biometric sensor and the verification value includes a biometrics value.

37. The computer system of claim 36 wherein the biometrics sensor comprises a fingerprint scanner.

38. The computer system of claim 36 wherein the biometric sensor comprises a retinal scanner.

39. The computer system of claim 32 wherein the token includes a validity time period value and said CPU retrieves said validity time period value and determines whether said time period has expired, and if said time period has expired, said CPU prevents the user account from being created.

40. The computer system of claim 39 wherein said CPU creates said account if said time period has not expired.

41. The computer system of claim 32 further including memory coupled to said CPU and wherein said token includes an executable application which said CPU copies to said memory and executes.

42. The computer system of claim 33 further including memory coupled to said CPU and wherein said token includes an executable application which said CPU copies to said memory and executes if said CPU successfully verifies said security value.

43. The computer system of claim 32 wherein said token reader includes a USB bus to which said token can be coupled.
